(19) United States
(12) Patent Application Publication
(10) Pub. No.: US 2024/0062435 A1
(43) Pub. Date: Feb. 22, 2024

(54) IMAGE GENERATION DEVICE AND METHOD OF GENERATING IMAGE

(71) Applicant: YAMAHA CORPORATION, Hamamatsu-shi (JP)

(72) Inventors: Kenji ISHIZUKA, Hamamatsu-shi (JP); Hidetaka IMAMURA, Hamamatsu-shi (JP); Keijiro SAINO, Hamamatsu-shi (JP); Taiki SHIMOZONO, Hamamatsu-shi (JP)

(21) Appl. No.: 18/468,784

(22) Filed: Sep. 18, 2023

Related U.S. Application Data
(63) Continuation of application No. PCT/JP21/12331, filed on Mar. 24, 2021.

(51) Int. Cl. G06T 11/00; G06T 7/20; G06T 13/40; G06T 17/00

(52) U.S. Cl. CPC G06T 11/00; G06T 7/20; G06T 13/40; G06T 17/00

(57) ABSTRACT

An image generation device is for a live distribution system that distributes, in real-time, a piece of music performed by a performer to terminal devices of a plurality of viewers through a communication network. The image generation circuit includes an obtaining circuit and an image generation circuit. The obtaining circuit obtains motion information regarding a motion of a first viewer of the distributed piece of music. The image generation circuit generates an image showing at least one avatar group that is being caused to motion based on the motion information in an imaginary space that corresponds to a performance of the piece of music. Each of the at least one avatar group includes avatars of a plurality of viewers.

### CROSS-REFERENCE TO RELATED APPLICATIONS

The present application is a continuation application of International Application No. PCT/JP2021/012331, filed Mar. 24, 2021. The contents of this application are incorporated herein by reference in their entirety.

### BACKGROUND

### Field

The present disclosure relates to an image generation device and a method of generating an image.

### Background Art

JP 2008-131379A discloses a system that distributes, live, a moving image of singing performance and/or musical performance. In this system, the singer(s) and musical performer(s) perform at different places. At each of the places, a camera is set. A control center synthesizes moving images obtained from the cameras to generate a distribution moving image, and distributes the distribution moving image to receiving terminals.

In physical live performances, musical performers perform while checking the audience's reactions. Likewise, musical performers in live distributions are desirably able to check the viewers' reactions while performing. Also, some viewers might wonder how to enjoy a particular piece of music and like to watch other viewers' reactions. In view of this need, it is preferable that viewers' reactions to a live distribution can be shared.

The present disclosure has been made in view of the above-described and other circumstances, and has an object to enable viewers' reactions to a live distribution to be shared.

### SUMMARY

One aspect is an image generation device for a live distribution system that distributes, in real-time, a piece of music performed by a performer to terminal devices of a plurality of viewers through a communication network. The image generation circuit includes an obtaining circuit and an image generation circuit. The obtaining circuit is configured to obtain motion information regarding a motion of a first viewer of the distributed piece of music. The image generation circuit is configured to generate an image showing at least one avatar group that is being caused to motion based on the motion information in an imaginary space that corresponds to a performance of the piece of music. Each of the at least one avatar group includes avatars of a plurality of viewer.

Another aspect is a method of generating an image. The method is performed by a computer used in a live distribution system that distributes, in real-time, a piece of music performed by a performer to terminal devices of a plurality of viewers through a communication network. The method includes obtaining motion information based on a motion of a first viewer of the distributed piece of music. The method also includes generating an image showing at least one avatar group that is being caused to motion based on the motion information in an imaginary space that corresponds to a performance of the piece of music. Each of the at least one avatar group includes avatars of a plurality of viewers.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a block diagram of a configuration of a live distribution system 1.

FIG. 2 is a functional block diagram of a configuration of a live distribution device 10.

FIG. 3 is a sequence chart showing a flow of processing performed by the live distribution system 1.

FIG. 4 illustrates an example image displayed on a display screen of a terminal device of a viewer.

FIG. 5 illustrates an example image displayed on a display screen of a terminal device of a performer.

### DESCRIPTION OF THE EMBODIMENTS

The present development is applicable to an image generation device and a method of generating an image.

By referring to the accompanying drawings, description will be made with regard to an image generation device according to one embodiment of the present disclosure.

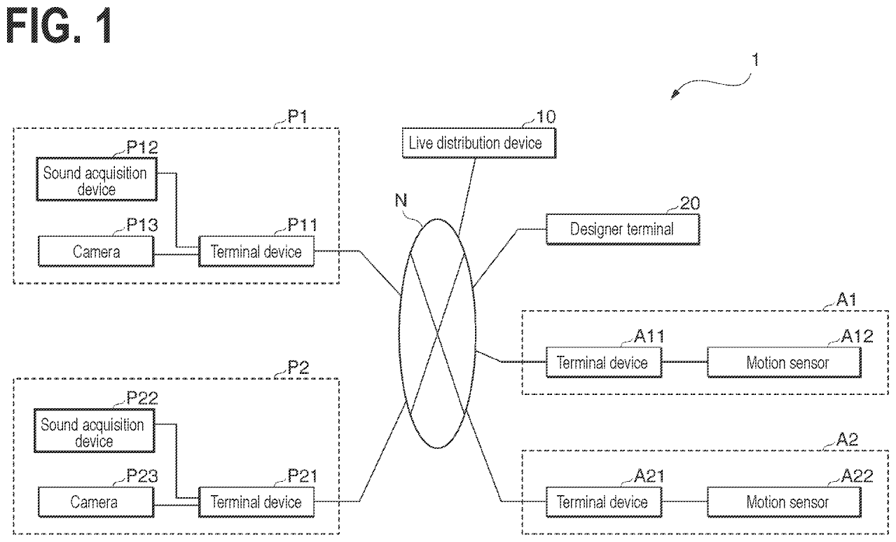

FIG. 1 is a block diagram of a configuration of the live distribution system 1. The live distribution system 1 uses the image generation device according to the one embodiment of the present disclosure. The live distribution system 1 includes the live distribution device 10, a designer terminal 20, a performer device group P1, a performer device group P2, a viewer device group A1, and a viewer device group A2. The live distribution device 10, the designer terminal 20, the performer device group P1, the performer device group P2, the viewer device group A1, and the viewer device group A2 are communicatively connected to each other through a network N.

The live distribution device 10 performs a live distribution. Specifically, the live distribution device 10 distributes, in real-time, content of a live musical performance performed by a performer to terminals of viewers. The live distribution device 10 is capable of performing two kinds of live distributions. In one kind of live distribution, performers gather at one live venue to perform one piece of music. In the other kind of live distribution, performers located at different live venues play different parts, such as a vocal, a guitar, a base, a drum, and a keyboard. In a case where performers located at different live venues perform one piece of music, the live distribution device 10 obtains a piece of performance data from a performer device group provided at each of the live venues, and synthesizes the piece of performance data obtained from the performer device groups. Then, the live distribution device 10 transmits the synthesized performance data to viewers' devices as live distribution data. The live venue may be a performer's home, a studio, a live venue, or any other place where musical performance can be done.

The performer device group P1 and the performer device group P2 are used by performers appearing in the live performance. The following description is an example in which a performer who uses the performer device group P1 to perform one piece of music and a performer who uses the performer device group P2 to perform the one piece of music are located at different live venues to perform the one piece of music. It is to be noted that one piece of music may be performed in a single live venue, instead of in a plurality of live venues. In this case, a single performer device group is used. The following description is an example in which two performer device groups are used. In a case where, however, there are three or more venues of musical performance, a performer device group may be provided at each of the venues. For example, in a case where there are different performance parts such as a vocal, a guitar, a base, a drum, and a keyboard, a different performer device group may be used to play each part at each venue.

The performer device group P1 includes a terminal device P11, a sound acquisition device P12, and a camera P13. The terminal device P11 is communicatively connected to the sound acquisition device P12 and the camera P13, and is communicably connected to the network N. The terminal device P11 includes various input devices such as a mouse, a keyboard, and a touch panel, and includes a display device. An example of the terminal device P11 is a computer.

The sound acquisition device P12 acquires sound and outputs, to the terminal device P11, a sound signal corresponding to the acquired sound. It suffices that the sound acquisition device P12 has at least one function among a sound sensor that acquires musical performance sound output from a musical instrument, an input device that receives a sound signal output from an electronic instrument, and a microphone that acquires a performer's vocal sound. While in this description a single sound acquisition device P12 is connected to the terminal device P11, a plurality of sound acquisition devices may be connected to the terminal device P11. For example, in a case where a performer sings while playing a musical instrument, it is possible to use a sound acquisition device as a microphone and another sound acquisition device to acquire sound of the musical instrument. The camera P13 takes an image of the performer who uses the performer device group P1. Then, the camera P13 outputs the image data to the terminal device P11. An example of the image data is movie data.

The performer device group P2 includes a terminal device P21, a sound acquisition device P22, and a camera P23. The terminal device P21 has a function similar to the function of the terminal device P11, the sound acquisition device P22 has a function similar to the function of the sound acquisition device P12, and the camera P23 has a function similar to the function of the camera P13. In view of this, the terminal device P21, the sound acquisition device P22, and the camera P23 will not be elaborated upon here.

The designer terminal 20 is used by a designer in charge of staging content of a live distribution. The designer terminal 20 inputs setting information to the live distribution device 10. The setting information is information to cause an avatar group to motion. Also, the setting information may be at least one piece of information among a venue design, an avatar motion pattern that is based on a piece of music, and a group classification of audience seats into groups.

The viewer device group A1 and the viewer device group A2 are used by viewers of a live distribution. The viewer device group A1 and the viewer device group A2 are used by different viewers.

The viewer device group A1 includes a terminal device A11 and a motion sensor A12.

The terminal device A11 includes various input devices such as a mouse, a keyboard, and a touch panel, and includes a display device.

The terminal device A11 is communicably connected to the motion sensor A12, and communicatively connected to the network N. Examples of the terminal device P11 include a computer, a smartphone, and a tablet.

The terminal device A11 receives an image signal from the live distribution device 10, and displays the image signal on the display screen. In displaying the image signal, the terminal device A11 is capable of changing a viewing position in an imaginary space based on an input operation by the viewer. Based on the image signal, the terminal device P11 generates three-dimensional information of a live venue in the imaginary space. Then, the terminal device P11 makes generates an image signal for displaying three-dimensional information indicating a live venue as seen from a specified viewing position. The terminal device P11 displays the generated image signal on the display screen.

The motion sensor A12 detects a motion of the viewer who is using the viewer device group A1. Then, the motion sensor A12 generates motion information based on the detected motion and outputs the motion information to outside. The motion sensor A12 is communicatively connected to the terminal device A11, and outputs the motion information to the terminal device A11.

The motion sensor A12 takes an image of the viewer and detects a posture of the viewer based on the image taken. Based on the detected posture of the viewer, the motion sensor A12 detects a motion of the viewer. The viewer's motion to be detected may be at least one of a motion of standing, a motion of raising the viewer's arm, a motion of rocking the viewer's body from side to side, and a motion of waving the viewer's hand. In order to detect any of these motions, the motion sensor A12 is installed near the display device of the terminal device A11, and the image-taking direction of the motion sensor A12 is adjusted in advance to ensure that the viewer viewing the live distribution is within the image-taking range of the motion sensor A12.

In a case where the motion sensor A12 detects a motion of the viewer based on an image, the motion sensor A12 detects, for example, a part of the viewer's body that the viewer has moved, the direction of the motion, and/or the speed of the motion. Then, the motion sensor A12 generates motion information including these pieces of detected information, and outputs the motion information to the terminal device of the viewer. The motion sensor A12 may also generate such motion information that indicates whether a particular part of the viewer's body has moved. Specifically, the motion sensor A12 may generate such motion information that uses a binary value to indicate whether a particular part of the viewer's body has moved. This configuration ensures that the motion information can be represented by a small volume of information (low-level information), reducing the load of transmitting the motion information from the terminal device of the viewer to the live distribution device 10. Also, the load on the network N is reduced.

The motion sensor A12 may be an acceleration sensor or a gyro sensor. In this case, the motion sensor A12 is attached to the body of the viewer or held in a hand of the viewer. Even in a case where an acceleration sensor or a gyro sensor is used, the motion sensor A12 may generate motion information that uses a binary value to indicate whether a part of the viewer's body has moved.

It is to be noted that the motion sensor A12 may have a function to be connected to the network N. In this case, the motion sensor A12 is capable of transmitting the motion information to the network N without intervention by the terminal device A11; that is, the motion sensor A12 does not have to transmit the motion information to the network N via the terminal device A11. The terminal device A11 and the motion sensor A12 is used by the same viewer, and this viewer sameness may be verified when the user logs in the terminal device A11 and the motion sensor A12 using the same log-in ID and password at the time of viewing a live distribution. Alternatively, it is possible to input in the terminal device A11 an individual identification number of the motion sensor A12 to register the user.

The viewer device group A2 includes a terminal device A21 and a motion sensor A22. The terminal device A21 has a function similar to the function of the terminal device A11, and the motion sensor A22 has a function similar to the function of the motion sensor A12. In view of this, the terminal device A21 and the motion sensor A22 will not be elaborated upon here.

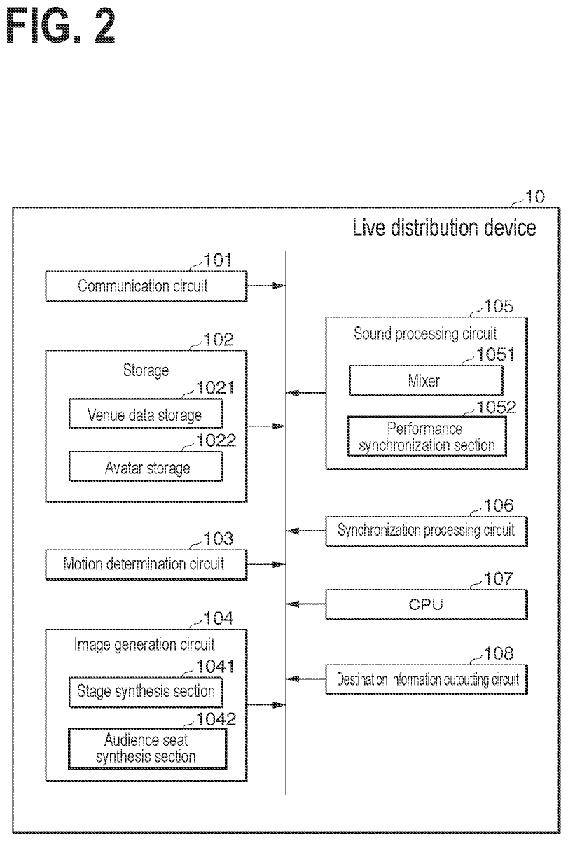

FIG. 2 is a functional block diagram of a configuration of the live distribution device 10.

The live distribution device 10 includes a communication circuit 101, a storage 102, a motion determination circuit 103, an image generation circuit 104, a sound processing circuit 105, a synchronization processing circuit 106, a CPU (Central Processing Unit) 107, and a destination information outputting circuit 108.

The communication circuit 101 is connected to the network N to communicate with other devices via the network N. For example, the communication circuit 101 functions as an obtaining circuit that obtains, from the terminal device of a viewer, motion information that is based on a motion of the viewer viewing a live distribution.

The storage 102 stores various kinds of data.

For example, the storage 102 includes a venue data storage 1021 and an avatar storage 1022.

The venue data storage 1021 stores venue data that indicates a live venue in an imaginary space. The venue data may be three-dimensional data that indicates a live venue in a three-dimensional space.

The avatar storage 1022 stores image data indicating avatars arranged in an imaginary space of a live venue. The avatars may be identical to each other in design for all viewers, or at least one avatar may be different in design from the other avatars for at least one viewer. In a case where each viewer is assigned a different design avatar, the avatar storage 1022 stores avatar data that indicates an avatar design for the each viewer (user). In an imaginary space of a live venue, there may be a merchandise stall that sells avatar shapes applicable to the viewer's avatar and items such as clothing and accessories wearable by the viewer's avatar. The merchandise stall may accept electronic money (digital cash) as a payment option. At the merchandise stall, the viewer can buy an avatar shape and/or items in accordance with the viewer's preferences, and apply the avatar shape and/or items to the viewer's avatar.

The storage 102 may be a storage medium such as an HDD (Hard Disk Drive), a flash memory, an EEPROM (Electrically Erasable Programmable Read Only Memory), a RAM (Random Access read/write Memory), and a ROM (Read Only Memory). Alternatively, the storage 102 may be a combination of these storage media. An example of the storage 102 is a nonvolatile memory.

Based on the motion information transmitted from the terminal device of the viewer, the motion determination circuit 103 determines which motion the viewer is making. The viewer's motion may be at least one of a motion of standing, a motion of raising the viewer's arm, a motion of rocking the viewer's body from side to side, and a motion of waving the viewer's hand.

The image generation circuit 104 generates an image signal that is based on a piece of music performed by a performer(s). The image generation circuit 104 includes a stage synthesis section 1041 and an audience seat synthesis section 1042.

The stage synthesis section 1041 synthesizes image data indicating a performer who is performing a piece of music over a stage in an imaginary space of a live venue indicated by venue data.

The audience seat synthesis section 1042 synthesizes the avatar corresponding to the viewer over an audience seat in the imaginary space of the live venue.

The image generation circuit 104 generates such an image signal that an image of the performer is synthesized over the stage in the imaginary space of the live venue by the stage synthesis section 1041 and that the avatar of the viewer is synthesized over the audience seat in the imaginary space of the live venue by the audience seat synthesis section 1042. The image generation circuit 104 transmits the generated image signal to the terminal device (the terminal device A11 or the terminal device A21) of the viewer via the communication circuit 101 and the network N.

The audience seat synthesis section 1042 of the image generation circuit 104 generates an image for causing an avatar group arranged in an imaginary space from which a live is distributed to motion based on motion information obtained from the motion determination circuit 103. An avatar group is obtained by classifying avatars of a plurality of viewers into a group.

In generating an image for causing an avatar group to motion, the audience seat synthesis section 1042 may cause the avatar group to which the avatar corresponding to the viewer belongs to motion based on motion information. For example, in an imaginary space of a live venue, each viewer is assigned an audience seat position in seat data. Specifically, each one viewer may be assigned an individual audience seat, or a plurality of viewers may be assigned an area that can accommodate the plurality of viewers. Upon detection of information motion of a viewer, the audience seat synthesis section 1042 determines an audience seat of this viewer based on the seat data. The audience seat synthesis section 1042 identifies a group that includes the viewer with the determined audience seat. The audience seat synthesis section 1042 applies the information motion of the viewer to motions of the plurality of avatars in the identified group.

Alternatively, the audience seat synthesis section 1042 may cause an avatar representing the entire group to motion based on the information motion of one viewer who belongs to the group. In this case, the avatar of the entire group can be caused to motion based on a motion of a representative viewer of the group.

The audience seat synthesis section 1042 may also analyze a tendency of motions of the viewers who belong to a group based on the motion information of the viewers, and cause the avatars of the group to motion based on the tendency. For example, there may be a case where some viewers in a group make a motion of jumping at some part of a piece of music. In this case, the number of viewers who jumped is detected, and if the number of viewers detected is equal to or more than a reference number (for example, if the number of viewers detected is half or more than half of all the viewers), the avatars that belong to the group are caused to motion (for example, caused to jump). Thus, a tendency of the viewers' motions may be analyzed on a group basis, and the avatar group may be caused to motion based on the tendency.

In this embodiment, the image generation circuit 104 is provided in the live distribution device 10. Alternatively, the image generation circuit 104 may be provided as a device independent of the live distribution device 10 and communicable with the live distribution device 10.

The sound processing circuit 105 generates a sound signal that is based on a piece of music performed by a performer(s).

The sound processing circuit 105 includes a mixer 1051 and a performance synchronization section 1052.

The mixer 1051 receives sound signals from the performer device groups, and synthesizes mixing sound signals among the received sound signals. For example, the mixer 1051 receives a sound signal of a musical instrument (for example, a guitar) played by the performer corresponding to the performer device group P1, a vocal sound of the performer corresponding to the performer device group P1, and a sound signal of a musical instrument (for example, a base) played by the performer corresponding to the performer device group P2. Then, the mixer 1051 generates a sound signal (a sound signal of an accompanied part) by mixing the sound signal of the musical instrument (for example, a guitar) played by the performer corresponding to the performer device group P1 with the sound signal of the musical instrument (for example, a base) played by the performer corresponding to the performer device group P2. In this case, the mixer 1051 outputs two sound signals, namely, the sound signal of the vocal sound of the performer corresponding to the performer device group P1 and the sound signal of the accompanied part.

The performance synchronization section 1052 synchronizes performance signals obtained from the performer device groups of the performers in charge of the parts of one piece of music. For example, the performance synchronization section 1052 synchronizes a performance signal of the vocal sound of the performer corresponding to the performer device group P1, a performance signal of the musical instrument played by the performer corresponding to the performer device group P1, and a performance signal of the musical instrument played by the performer corresponding to the performer device group P2.

The synchronization processing circuit 106 synchronizes the sound signal generated by the image generation circuit 104 and the image signal generated by the sound processing circuit 105.

The CPU 107 controls the elements of the live distribution device 10.

The destination information outputting circuit 108 outputs destination information regarding a destination of an article. The destination information is based on personal information of a viewer corresponding to a special avatar.

At least one of the motion determination circuit 103, the image generation circuit 104, the sound processing circuit 105, the synchronization processing circuit 106, and the destination information outputting circuit 108 may be implemented by, for example, executing a computer program at a processor such as the CPU 107, or may be implemented by a dedicated electronic circuit.

Next, an operation of the live distribution system 1 will be described.

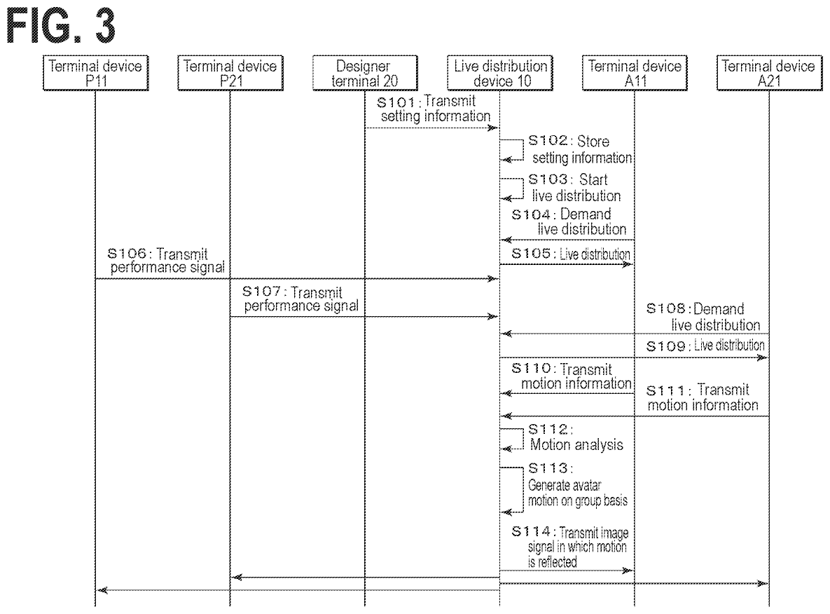

FIG. 3 is a sequence chart showing a flow of processing performed by the live distribution system 1.

In response to an input operation by a designer, the designer terminal 20 transmits setting information to the live distribution device 10 (step S101).

The live distribution device 10 receives the setting information transmitted from the designer terminal 20 and stores the setting information in the storage 102 (step S102).

Upon arrival of a live distribution start time, the live distribution device 10 starts a live distribution based on the setting information stored in the storage 102 (step S103). Specifically, the live distribution device 10 receives image signals and performance signals transmitted from the performer device group P1 and the performer device group P2, and distributes the performance signals and an image signal obtained by synthesizing the image signals over an imaginary space of the live venue.

In response to an input operation by the viewer corresponding to the terminal device A11, the terminal device A11 transmits a purchase demand to the live distribution device 10 to enable the viewer to purchase an electronic ticket to view the live distribution. The terminal device A11 also transmits a live distribution demand to the live distribution device 10 (step S104). In response to the purchase demand, the live distribution device 10 issues an electronic ticket to the viewer's terminal device A11. Specifically, the live distribution device 10 assigns the viewer an audience seat in the imaginary space of the live venue, and permits the viewer to view the live distribution. The electronic ticket may be reserved in advance, before being purchased, or may be sold at the time of viewing the live distribution.

In response to the live distribution demand from the terminal device A11, the live distribution device 10 synchronizes the image signal and the performance signals, and transmits the synchronized signals to the terminal device A11 (step S105). In this manner, the live starts to be distributed to the terminal device A11.

After a musical performance has started, a performance signal is transmitted from the terminal device P11 to the live distribution device 10 (step S106), and a performance signal is transmitted from the terminal device P21 to the live distribution device 10 (step S107). The live distribution device 10 receives the performance signals and distributes the performance signals to the terminal device of a viewer. The live distribution device 10 may also distribute the performance signals to the terminal device of each performer. Upon receipt of the performance signals from the live distribution device 10, the terminal device of the each performer outputs the performance signals to a speaker or a headphone of the each performer. Thus, the performance signals are output to outside in the form of sound. This enables the each performer to perform the performer's performance while listening to the sound of other performers' performance located in other places.

In response to an input operation by the viewer, the terminal device A21 transmits a live distribution demand to the live distribution device 10 (step S108).

In response to the live distribution demand from the terminal device A21, the live distribution device 10 transmits the image signal and the performance signals to the terminal device A21 (step S109). Thus, a live distribution to the terminal device A21 starts.

The performers may not necessarily perform a musical performance alone; there may be a case where a performer talks (makes a call) to the viewers using a microphone in the middle of a piece of music, such as “Can you guys on the far side hear me?” In this case, those viewers whose seats are on the far side in the imaginary space of the live venue can show a response by a body movement such as raising arms.

Upon detection of raising of the viewer's arm, the motion sensor A12 outputs, to the terminal device A11, motion information that is based on the detection. The terminal device A11 transmits, to the live distribution device 10, the motion information obtained from the motion sensor A12 together with identification information of the terminal device A11 (step S110).

Upon detection of raising of the viewer's arm, the motion sensor A22 outputs, to the terminal device A21, motion information that is based on the detection. The terminal device A21 transmits, to the live distribution device 10, the motion information obtained from the motion sensor A22 together with identification information of the terminal device A21 (step S111).

Upon receipt of the motion information from the terminal device A11 and the motion information from the terminal device A21, the motion determination circuit 103 of the live distribution device 10 determines motions of the viewers based on the motion information from the terminal device A11 and the motion information from the terminal device A21. Specifically, the motion determination circuit 103 determines that the motion indicated by the motion information from the terminal device A11 is an arm raising motion, and the motion indicated by the motion information from the terminal device A21 is an arm raising motion (step S112).

Based on the determination made by the motion determination circuit 103, the image generation circuit 104 aggregates the pieces of motion information on an audience-seat group basis. For example, there may be a case where a front row side of the audience seats (audience seats nearer to the stage) is referred to as first group, and a back row side of the audience seats (audience seats farther away from the stage) is referred to as second group. In this case, the image generation circuit 104 counts the number of pieces of motion information that indicate an arm raising motion and that have been received from the terminal devices of viewers who belong to the first group. Then, the image generation circuit 104 determines whether the obtained count is equal to or more than a reference number. Here, it will be assumed that the performer's call is intended for those viewers on the back row side and that most of those viewers on the front row side do not raise their arms. In this case, the obtained count is less than the reference value, and the image generation circuit 104 does not cause the avatars that belong to the first group to make an arm raising motion. There may be a case where some of the viewers who belong to the first group make an arm raising motion. Even in this case, those avatars provided at positions corresponding to the first group in the imaginary space of the live venue may be prevented from raising the avatars' arms.

If the performer's call is intended for those viewers on the back row side and if these viewers are excited about the piece of music being performed, many of these viewers would raise their arms in response to the call. In this case, the number pieces of motion information that indicate an arm raising motion and that have been received from the terminal devices of viewers who belong to the second group exceeds the reference value. In this case, the image generation circuit 104 causes the avatars that belong to the second group to make an arm raising motion. Specifically, arm raising images of the avatars that belong to the second group are synthesized over the second group (step S113).

After the images have been synthesized, the image generation circuit 104 transmits an image signal to the terminal devices of the viewers and the terminal devices of the performers via the communication circuit 101 and the network N (step S114). The image signal indicates that the avatars that belong to the second group raised their arms. The image signal causes an image to be displayed on display screens of the terminal devices of the viewers (for example, the terminal device A11 and the terminal device A21). The image shows the avatars on the front row side dropping their arms and the avatars on the back row side raising their arms. Likewise, the image signal causes an image to be displayed on display screens of the terminal devices of the performers (the terminal device A11 and the terminal device A21). The image shows the avatars on the front row side dropping their arms and the avatars on the back row side raising their arms.

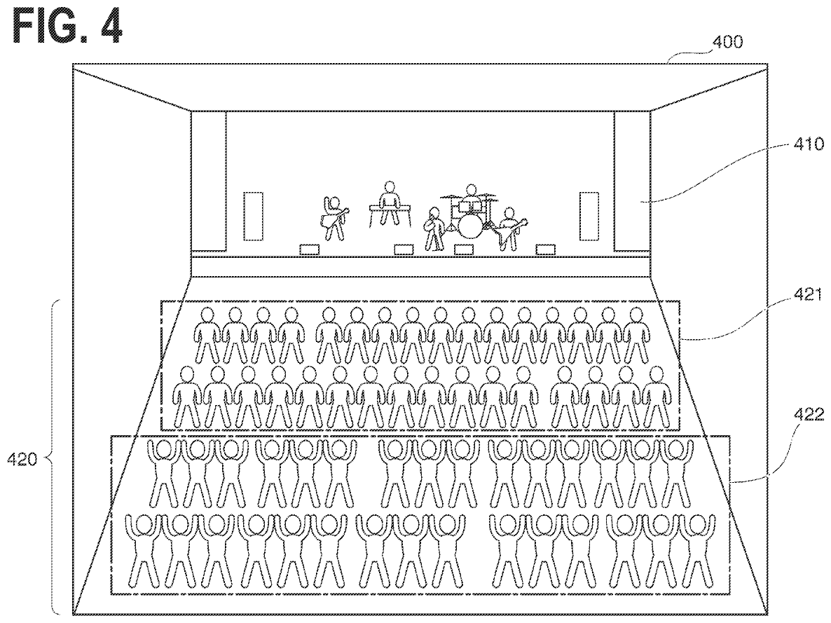

FIG. 4 illustrates an example image displayed on a display screen of a terminal device of a viewer.

The terminal device of a viewer displays an image of the stage as seen from the audience seats.

Specifically, an image 410 and an image 420 are displayed on the display screen, 400, of the terminal device of a viewer.

The image 410 shows the performers performing a musical performance on the farthest side. The image 420 shows the audience seats in front of the stage. In the audience seats, a seat group in an area nearer to the stage (the front row side) is labeled as first group 421, and a seat group in an area farther away from the stage (the back row side) is labeled as second group 422.

As illustrated in FIG. 4, by looking at the display screen 400, the viewers on the front row side are able to see that the avatars on the front row side are not raising their arms. If a viewer on the front row side did not raise the viewer's arms, the viewer is able to see that the viewer made the same reaction as the other viewers on the front row side. Even if this viewer raised the viewer's arms, the avatar corresponding to the viewer is displayed in a state of not raising arms. This enables the viewer to see that the viewer's motion was different from the motions of those around the viewer. The viewer may also cause the viewer's avatar to be displayed such that the avatar is making a motion identical to the motions of the avatars of those around the viewer.

The viewers on the back row side are able to see on the display screen 400 that the avatars on the back row side are raising their arms. If a viewer on the back row side raised the viewer's arm, the viewer is able to see that the viewer made the same reaction as the other viewers on the back row side. Even if this viewer did not raise the viewer's arms, the avatar corresponding to the viewer is displayed in a state of raising arms. This enables the viewer to see that the viewer's motion was different from the motions of those around the viewer. The viewer may also cause the viewer's avatar to be displayed such that the avatar is making a motion identical to the motions of the avatars of those around the viewer.

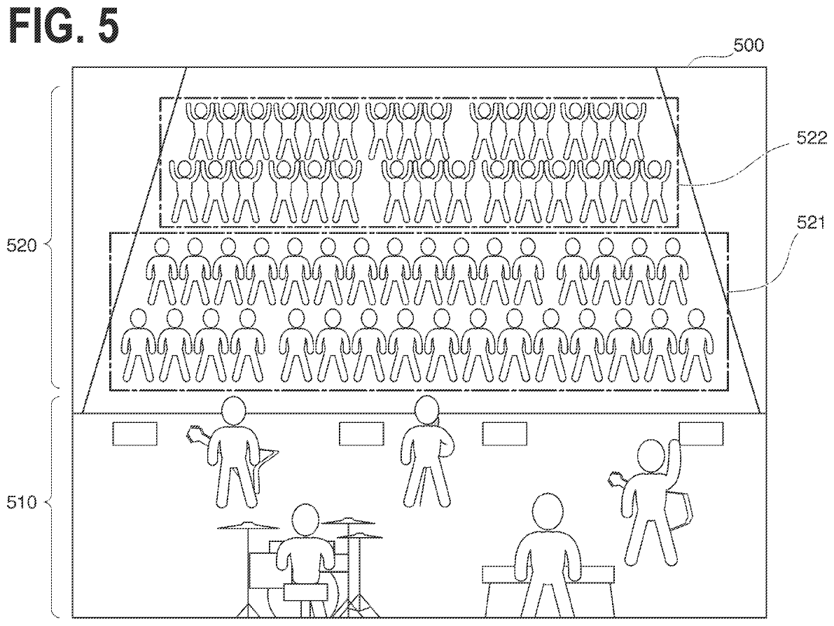

FIG. 5 illustrates an example image displayed on a display screen of a terminal device of a performer.

The terminal device of a performer displays an image of the audience seats as seen from the stage. Thus, the image generation circuit 104 may have a function to generate an image signal in a case where the stage is seen from the audience seat side. Alternatively or additionally, the image generation circuit 104 may have a function to generate an image signal in a case where the audience seats are seen from the stage.

An image 510 and an image 520 are displayed on the display screen, 500, of the terminal device of a performer. The image 510 shows the stage on the nearest side, and the image 520 shows the audience seats on the far side beyond the stage. In the audience seats, a seat group in an area nearer to the stage (the front row side) is labeled as first group 521, and a seat group in an area farther away from the stage (the back row side) is labeled as second group 522.

The performers are able to see on the display screen 500 that the avatars on the front row side (first group) are not raising their arms, while the avatars on the back row side (second group) are raising their arms. That is, the performers are able to see that the viewers on the back row side reacted to the performer's call.

In this respect, if the determination as to whether the viewers on the back row side are raising their arms is made on an individual avatar basis, instead of a group basis, there may be a variation among the avatars in raising of their arms. In this case, even if a substantial number of viewers on the back row seats are raising their arms, the performers can not sufficiently receive the viewers' reactions to the performers' performance. In the one embodiment, all the avatars on the back row side raise their arms if the number of arm-raising viewers on the back row side is equal to or more than a reference number. This configuration enables the performers to feel that they have received good reactions from the viewers' to the performers' performance. As a result, the performers enjoy their performance more in the one embodiment. Also, the viewers' reactions to the performers' performance are represented on a group basis. This creates a feeling of unity among the viewers as they go through the piece of music.

In live distributions, the performers may not necessarily be performing in front of actual viewers, and thus may find it difficult to see how the viewers are reacting to the performers' performance. There may be a case where a viewer inputs a comment in the viewer's terminal device during a live distribution, and the viewer's terminal device transmits the comment to the performers' terminal devices in the form of text data so that the text data is displayed on the display screens of the performers' terminal devices. In this case, the viewers' reactions can be expressed in the form of character strings. In actual live venues, however, it is the audience's applause and body movements that the performers receive as reactions. Therefore, displaying character strings on the performers' display screens is a form of reaction different from the viewers' reactions in actual live venues. Thus, it is difficult for the performers in live distributions to see how the viewers are reacting. In the one embodiment, the avatars are cause to motion on a group basis based on the viewers' motions. This configuration enables the performers to feel as if the performers are watching the audience's motions in actual live venues.

In the one embodiment described hereinbefore, the image generation circuit 104 displays an image that depends on whether the viewers are raising their arms. The avatars' motions, however, may be other than an arm raising motion.

For example, in a case of a piece of music performed in a slow rhythm, the viewers may listen to the piece of music while swinging from side to side to the rhythm. In this case, each motion sensor detects a motion of swinging from side to side and outputs this motion as motion information. The terminal device of each viewer transmits this motion information to the live distribution device 10.

Based on the motion information, the image generation circuit 104 generates an image showing the avatars swinging from side to side on a group basis, and distributes the image to the terminal devices of the performers.

By looking at this image, the performers are able to see whether the viewers are enjoying the piece of music by swinging to the rhythm. Also, by moving to the rhythm on a group basis, the viewers can feel a feeling of unity on an area basis in the live venue.

Each viewer may look at the motions of the other viewers around the each viewer's seat, and see the rhythm to which the other viewers are swinging. This enables the each viewer and the other viewers to swing to the same rhythm, sharing how to enjoy the piece of music.

The image generation circuit 104 may also extract a frequency corresponding to a motion, and generate an image of the avatar group motioning based on the extracted frequency. In extracting a frequency, the image generation circuit 104 subjects motion information to Fourier transformation to calculate signal strengths for the frequencies included in the motion information. Then, based on the obtained signal strengths, the image generation circuit 104 extracts a frequency from all frequency band. Specifically, the image generation circuit 104 may extract a frequency with the highest signal strength.

In a case where the viewer is making a motion of swinging from side to side, the image generation circuit 104 may extract a frequency from the periodic motion of swinging from side to side, and based on the extracted frequency, cause the avatar group to make a motion of swinging from side to side.

In a case where the avatar group is caused to motion based on a frequency, the viewer's motion is not reproduced as it is; instead, a periodic characteristic is extracted from the viewer's motion and the avatar group is caused to motion based on the characteristic.

The image generation circuit 104 may calculate, based on motion information, a signal strength corresponding to the motion, and generate an image of the avatar group motioning based on the calculated signal strength. In extracting a signal strength, the image generation circuit 104 subjects motion information to Fourier transformation to calculate signal strengths for the frequencies included in the motion information. Then, the image generation circuit 104 extracts a signal strength from the signal strengths calculated on a frequency basis. For example, the image generation circuit 104 may extract the highest signal strength.

The image generation circuit 104 may also display, together with the avatar group, the viewer's avatar motioning based on the viewer's motion. Specifically, the image generation circuit 104 displays the avatar of the viewer together with the avatar group, whose avatars make the same motion as a group. In this case, the image generation circuit 104 causes the avatar of the viewer to motion based on the motion information obtained from the viewer. With this configuration, the terminal device of the viewer displays the viewer's avatar motioning based on the viewer's motion, together with the avatar group, which motions as a group. This enables the viewer to find, from the plurality of avatars arranged in the imaginary space of the live venue, the viewer's avatar motioning based on the viewer's motion. Thus, the viewer is able to identify the viewer's own avatar in the live venue.

It may be the image generation circuit 104 that generates an image of the viewer's avatar motioning based on the viewer's motion, together with the avatar group, which motions as a group. Alternatively, the terminal device of the viewer may generate such image. For example, the live distribution device 10 distributes, to the terminal device of the viewer, an image of the avatar group, which motions as a group. The viewer's terminal device displays, on its display screen, an image signal based on an image signal distributed from the live distribution device 10. Simultaneously, the viewer's terminal device synthesizes the avatar corresponding to the viewer over the image signal and displays the resulting synthesized image signal. Thus, it is not necessary for the live distribution device 10 to synthesize the avatar corresponding to the viewer; this avatar can be synthesized at the terminal device of the viewer. This reduces the processing load of synthesizing an image at the live distribution device 10.

The image generation circuit 104 may also cause a motion to be made based on motion information and at a timing of arrival of a predetermined part included in a piece of music distributed live. When a piece of music is performed in an actual live venue, there may be a case where the audience enjoy a piece of music by making the same motion such as jumping up in unison at a timing of arrival of a particular part of a piece of music. Some pieces of music are even known for routine motions made at a timing of arrival of a particular part. In a case where such piece of music is known to be performed in a live distribution in advance, the storage 102 stores in advance the timing of the particular part of the piece of music linked to a motion pattern in which the avatar is caused to motion. After start of performance of this piece of music, viewers make a predetermined motion at the timing of arrival of the particular part. Based on motion information obtained at this timing, the image generation circuit 104 determines whether the number of viewers who made the predetermined motion is equal to or more than a reference number. If the number of viewers is equal to or more than the reference number, the image generation circuit 104 causes the avatar group to motion in the motion pattern linked to the timing of the particular part of the piece of music.

In this respect, it is possible to determine in advance which motion the avatar group is caused to make at the time of arrival of a particular part of a piece of music based on motion information. This ensures that, for example, the designer is able to consider how to direct an image in a live distribution and register in advance the considered image in the storage 102 of the live distribution device 10 using the designer terminal 20. Also, a plurality of patterns may be registered in advance for the motion of the avatar group. In this case, the designer may input, from the designer terminal 20, which motion pattern to be used in consideration of how the viewers viewing the live distribution are charged up with the piece of music and/or the atmosphere of the entire venue. This ensures that at the timing of arrival of the particular part of the piece of music, the image generation circuit 104 is able to cause the avatar group to motion in accordance with the motion pattern, among the registered motion patterns, that has been specified from the designer terminal 20.

In a case where the genre of the music performed in actual venues is classical music, there may be a case where the audience listen to the piece of music and do not move much during the performance; instead, the audience give a standing ovation after the performance. In this case, some viewers may possibly make such a motion as standing and applauding before the performance ends. This may cause some avatars to make a motion of standing and/or a motion of applauding in the middle of the piece of music. In this case, the performer may like the audience to enjoy the piece of music without making any motion during the performance. In this case, the storage 102 stores in advance the timing of the end of the piece of music and a standing ovation motion. Upon detection of the end of the piece of music, the image generation circuit 104 causes the avatar group to motion based on the motion information. This enables the performer to feel acknowledge the viewers' reactions after the end of the performance. There may be a case where a viewer makes a motion of standing and/or a motion of applauding shortly before the piece of music ends. Even in this case, the avatar of this viewer may be prevented from motioning in the middle of the piece of music in the presence of other viewers and performers, and cause to motion at the timing of the end of the piece of music.

The image generation circuit 104 may also cause the avatar group to motion based on the genre of a piece of music distributed live. For example, in a case where the music performed in actual venues is jazz music, there may be a case where the audience enjoy the piece of music by swinging their bodies to the rhythm of the piece of music. In a case where the music performed is classical music, there may be a case where the audience do not move much during performance of the piece of music, and make a motion such as applauding after the end of the performance. In a case where the music performed is pops, there may be a case where the audience enjoy the piece of music by raising and waving their hands and/or applauding while listening to the piece of music. Thus, the way of enjoying the music may vary depending on the genre of music.

The storage 102 stores music genres linked to motion patterns of the avatar group. The image generation circuit 104 determines the genre of the piece of music performed, and reads from the storage 102 a motion pattern corresponding to the determined genre of the piece of music. The image generation circuit 104 may, upon receipt of motion information, cause the avatar group to motion based on the read motion pattern.

In a case where pieces of music performed in a live distribution are determined in advance, the storage 102 stores genre information indicating genre on a live basis or a music piece basis. The image generation circuit 104 may read the genre information to determine the genre of a piece of music performed.

Also in the one embodiment described hereinbefore, the avatar is caused to make the motion indicated by the motion information obtained from the viewer. Alternatively, the avatar may be caused to make a motion different from the motion indicated by the motion information obtained from the viewer. For example, the storage 102 stores in advance avatar motion patterns based on pieces of music and/or parts of pieces of music. In a case where there is a change in motion judging from the motion information, or in a case where a particular motion has been made judging from the motion information, the image generation circuit 104 may read a motion pattern from the storage 102 and cause the avatar group to motion based on the read motion pattern. This ensures that in a case where the avatar is caused to jump, the viewer may not necessarily need to actually jump; instead, the viewer may only need to make a simple motion such as raising the viewer's hand and moving the viewer's hand from side to side. Then, the avatar group may be caused to make a motion that is different from the detected simple motion.

The communication circuit 101 may obtain motion information that is based on the motion by the performer in the performer device group P1. For example, a motion sensor is provided in any of the performer device groups. In the following description, a motion sensor is provided in the performer device group P1. The motion sensor generate motion information that is based on the motion by the performer, and outputs the motion information to the terminal device P11. The terminal device P11 receives the motion information from the motion sensor and transmits the motion information to the live distribution device 10. The live distribution device 10 generates an image signal based on the motion information transmitted from the terminal device P11.

For example, in actual live venues, there may be a case where a performer on the stage throws giveaways, such as a plectrum, a towel, and a ball, toward the audience seats. This kind of staging is preferably performable in live distributions as well to provide a live feel.

The image generation circuit 104 detects the motion of throwing an article by the performer. Then, based on this motion, the image generation circuit 104 estimates a dropping position of the article in the imaginary space. The image generation circuit 104 may estimate a trajectory and/or a dropping position of the thrown article by calculating the trajectory and/or the dropping position from a throwing direction and a throwing motion speed based on the motion information obtained from the performer. The image generation circuit 104 draws an image of the article along the obtained trajectory, and distributes the image to the terminal devices of the viewers. Thus, on the display screens of the terminal devices of the viewers, the viewers are able to see that an article has been thrown toward the audience seats by the performer and see the trajectory of the thrown article.

In a case where the thrown article has dropped near the viewer's position in the imaginary space in which the viewer exists, the viewer makes a receiving motion such as raising a hand. The receiving motion is detected by the motion sensor and transmitted to the live distribution device 10.

The live distribution device 10 identifies avatars included in a predetermined area including the dropping point of the article, and determines these avatars as one group. Then, based on the information motion of viewers corresponding to the area, the live distribution device 10 generates an image of the avatars motioning and synthesizes this image over the image of the imaginary space. Then, the live distribution device 10 distributes the synthesized image.

This ensures that an image that is based on the article-throwing motion by the performer can be distributed, and that reactions in the venue to the article-throwing motion can be shared among the viewers and the performers. Based on the estimated dropping position, the image generation circuit 104 identifies an avatar capable of receiving the article in the imaginary space, and regards this avatar as a special avatar. For example, the image generation circuit 104 identifies an avatar closest to the dropping position, and regards this avatar as a special avatar. Specifically, the image generation circuit 104 may select an avatar from among the avatars that are positioned in a predetermined range and that have made the receiving motion. Then, the image generation circuit 104 may regard the selected avatar as a special avatar.

The live distribution system 1 includes the destination information outputting circuit 108. The destination information outputting circuit 108 may output article destination information that is based on personal information of the viewer corresponding to the special avatar. The destination information includes, for example, the viewer's address and full name. The destination information may further include telephone number. The storage 102 may store, for example, personal information at the time of user registration. An administrator of the live distribution device 10 receives the article from the performer. Then, the administrator sends off the article based on the personal information output from the live distribution device 10. This ensures that the viewer is able to actually receive the article, bringing the viewer a great feeling of joy. In this respect, the actual article may be sent off to the viewer or an avatar decorating item may be given to the viewer. In a case where an avatar decorating item is given to the viewer, the viewer who has been given the item is able to have the viewer's avatar decorated with the item and displayed in the decorated state in the imaginary space. This ensures that the fact that the viewer has obtained the item can be shared among the other users and the performers.

In the above-described embodiment, the image generation circuit 104 has been described as generating an image of the avatar group motioning. Another possible embodiment is that the image generation circuit 104 generates information indicating that the avatar group is caused to motion and that the image generation circuit 104 transmits this information to the terminal device of the performer and/or the terminal device of the viewer via the communication circuit 101 and the network N. In this case, based on the information indicating that the avatar group is caused to motion, each terminal device may generate an image showing the avatar group motioning and display the image on the display screen of the each terminal device. This reduces the load of image processing at the live distribution device 10, and reduces the volume of information to be transmitted to the each terminal device via the network N. Even if the viewers' reactions are transmitted in a small volume of information, the smallness ensures that the viewers' reactions can be displayed on the display screen of the each terminal device.

A program for implementing the functions of each of the processing circuits illustrated in FIG. 1 may be stored in a computer readable recording medium. The program recorded in the recording medium may be read into a computer system and executed therein. An operation management may be performed in this manner. As used herein, the term “computer system” is intended to encompass hardware such as OS (Operating System) and peripheral equipment.

Also as used herein, the term “computer system” is intended to encompass home-page providing environments (or home-page display environments) insofar as the WWW (World Wide Web) is used.

Also as used herein, the term “computer readable recording medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable recording medium” is intended to encompass a recording medium that holds the program for a predetermined period of time. An example of such recording medium is a volatile memory inside a server computer system or a client computer system. It will also be understood that the program may implement only some of the above-described functions, or may be combinable with a program(s) stored in the computer system to implement the above-described functions. It will also be understood that the program may be stored in a predetermined server, and that in response to a demand from another device or apparatus, the program may be distributed (such as by downloading) via a communication line.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. An image generation device for a live distribution system that distributes, in real-time, a piece of music performed by a performer to terminal devices of a plurality of viewers through a communication network, the image generation circuit comprising:
an obtaining circuit configured to obtain motion information regarding a motion of a first viewer of the distributed piece of music; and
an image generation circuit configured to generate an image showing at least one avatar group that is being caused to motion based on the motion information in an imaginary space that corresponds to a performance of the piece of music, each of the at least one avatar group including avatars of a plurality of viewers.

2. The image generation device according to claim 1,
wherein the at least one avatar group includes a first avatar group to which a first avatar, among the avatars, of the first viewer belongs, and
wherein the image generation circuit is configured to cause the first avatar group to motion based on the motion information.

3. The image generation device according to claim 1, wherein, based on the motion information, the image generation circuit is configured to:
extract a frequency corresponding to the motion; and
generate the image based on the extracted frequency.

4. The image generation device according to claim 1, wherein, based on the motion information, the image generation circuit is configured to:
calculate a signal strength corresponding to the motion; and
generate the image based on the calculated signal strength.

5. The image generation device according to claim 1, wherein the image generation circuit is configured to display, together with the at least one avatar group, a first avatar motioning based on the motion of the first viewer.

6. The image generation device according to claim 1, wherein, based on the motion information, the image generation circuit is configured to cause the at least one avatar group to motion at a timing of arrival of a predetermined part included in the distributed piece of music.

7. The image generation device according to claim 1,
wherein, based on the motion information, the image generation circuit is configured to detect a number of viewers, among the plurality of viewers who belong to a group, who have made the motion, and
wherein, in a case where the detected number is equal to or more than a reference number, the image generation circuit is configured to cause the at least one avatar group to motion.

8. The image generation device according to claim 1, wherein the image generation circuit is configured to cause the at least one avatar group to motion based on a genre of the distributed piece of music.

9. The image generation device according to claim 1,
wherein the obtaining circuit is configured to obtain the motion information such that the motion information is based on a motion of throwing an article by a performer, and
wherein the image generation circuit is configured to:
based on the motion information regarding the motion of throwing the article by the performer, estimate a dropping point of the article in the imaginary space; and
based on the estimated dropping point, identify a special avatar, among the avatars, that is capable of receiving the article in the imaginary space.

10. The image generation device according to claim 9, further comprising a destination information outputting circuit configured to output destination information regarding a destination of the article, the destination information being based on personal information of a viewer, among the plurality of viewers, that corresponds to the special avatar.

11. A method of generating an image, the method being performed by a computer used in a live distribution system that distributes, in real-time, a piece of music performed by a performer to terminal devices of a plurality of viewers through a communication network, the method comprising:
obtaining motion information based on a motion of a first viewer of the distributed piece of music; and
generating an image showing at least one avatar group that is being caused to motion based on the motion information in an imaginary space that corresponds to a performance of the piece of music, each of the at least one avatar group including avatars of a plurality of viewers.

12. The image generation method according to claim 11, further comprising, based on the motion information:
extracting a frequency corresponding to the motion; and
generating the image based on the extracted frequency.

13. The image generation method according to claim 11, further comprising, based on the motion information:
calculating a signal strength corresponding to the motion; and
generating the image based on the calculated signal strength.

14. The image generation method according to claim 11, further comprising displaying, together with the at least one avatar group, a first avatar motioning based on the motion of the first viewer.

15. The image generation method according to claim 11, further comprising, based on the motion information, causing the at least one avatar group to motion at a timing of arrival of a predetermined part included in the piece of music.

16. The image generation device according to claim 2, wherein, based on the motion information, the image generation circuit is configured to:
extract a frequency corresponding to the motion; and
generate the image based on the extracted frequency.

17. The image generation device according to claim 2, wherein, based on the motion information, the image generation circuit is configured to:
calculate a signal strength corresponding to the motion; and
generate the image based on the calculated signal strength.

18. The image generation device according to claim 3, wherein, based on the motion information, the image generation circuit is configured to:
calculate a signal strength corresponding to the motion; and
generate the image based on the calculated signal strength.

19. The image generation device according to claim 2, wherein the image generation circuit is configured to display, together with the at least one avatar group, a first avatar motioning based on the motion of the first viewer.

20. The image generation device according to claim 3, wherein the image generation circuit is configured to display, together with the at least one avatar group, a first avatar motioning based on the motion of the first viewer.
